(19) United States
(12) Patent Application Publication
(10) Pub. No.: US 2008/0307331 A1
(43) Pub. Date: Dec. 11, 2008

(54) GRAPHIC INFORMATION GENERATION SYSTEM

(75) Inventor: Motoichi Kuwatani, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/127,153

(22) Filed: May 27, 2008

(30) Foreign Application Priority Data
Jun. 5, 2007 (JP) 2007-149432

(51) Int. Cl. G06F 3/048

(52) U.S. Cl. 715/763

(57) ABSTRACT

There is realized a graphic information generation system capable of allowing alteration at a quote-destination with linkage kept in continuous state, and enlarging a link part size by integrating similar link parts in one, to thereby implement customizing. In the graphic information generation system for generating a graphic object file by quoting a predetermined link part from a link part tool for retaining link parts for graphic display into graphic builder means while link-cataloging the link part quoted in the link part tool, the graphic information generation system comprises a customizing processor for customizing the link part as quoted, and link-cataloging a customized part in the link part tool.

### FIELD OF THE INVENTION

The invention related to a graphic information generation system for generating a graphic object file by quoting a predetermined link part from a link part tool for retaining link parts for graphic display into graphic builder means, and link-cataloging the link part as quoted in the link part tool.

### BACKGROUND OF THE INVENTION

In connection with a conventional operation monitoring display device for quoting a predetermined link part from a link part tool for storing link parts for graphic display of a face plate of an instrument into graphic builder means, thereby generating a face plate object file of the instrument, a technology has been disclosed in Patent Document 1.

FIG. 8 is a functional block diagram showing a configuration example of a distributed computer control system to which a conventional graphic information generation system is connected. An operation•monitoring device 10 is provided with a graphic object display 11, and is connected to a control bus 20.

Each of controllers 31, 32, . . . , 3n, connected to the control bus 20, communicates with the operation•monitoring device 10 via the control bus 20, and also communicates with each of plant equipment 51, 52, . . . , 5n via an I/O unit 40, thereby controlling those of the plant equipment.

A graphic information generation system 60 is connected to the control bus 20, and generates a graphic object file to be displayed on the graphic object display 11 of the operation•monitoring device 10, thereby downloading the graphic object file to the operation•monitoring device 10 via the control bus 20.

The graphic information generation system 60 comprises a link part tool 61, graphic builder means 62, a graphic object file 63, and updating means 64. The link part tool 61 retains link parts for graphic display, holding link-catalog information on the link parts as quoted.

The graphic builder means 62 is provided with a graphic window for executing various processing through dialogue with an operator. A link part edit function calls up a link part from the link part tool 61 to an edit display screen of the graphic window to be then edited, thereby retaining edit results in the link part tool 61.

A graphic object file generating function calls up link parts from the link part tool 61 to the edit display screen of the graphic window, and generates the graphic object file 63 by quoting the link parts to be retained therein while link-cataloging the link parts as quoted in the link part tool 61.

Update means 64 calls up a link-cataloged part in the link part tool 61 according to an update instruction instructed from a link part update dialog screen in the graphic window provided in the graphic builder means 62 to thereby update in batch processing all link-cataloged parts quoted in the graphic object file 63 to be replaced with the latest data.

FIG. 9 is a functional correlation view concerning editing, retaining, quoting, link-cataloging, and updating with respect to a link part. A link part tool file is managed by a link part tool window W1. The editing of a link part is executed by calling up a link part as an edit target to an edit window W2, and edit results are retained in the link part file via the link part tool window W1.

At the time of quoting a link part, a link part as retained is called up in the link part tool window W1 to be then edited in graphic windows W3, W4, and edit results thereof are retained in the graphic object files GR0001.edf, and GR0002.edf while the link part as quoted is link-cataloged in the link part tool 61 via the link part tool window W1.

In update processing, a link part file as link-cataloged in a link part update window W5 is called up, and link parts quoted in the graphic object file as a quote-destination are updated in batch processing to be thereby replaced with the latest data. Each of the graphic object files holds update history information, and detects mismatch between a link part and the link part file, at the quote-destination, by utilizing the information, thereby updating the link part so as to match the content of the link part file.

The graphic information generation system 60 is a tool for generating the graphic object file where a main line, tanks, pumps, and control valves are rendered to assist the operator in operating a plant with ease.

There are the needs for causing the graphic object file as generated to graphically exhibit flows of raw materials, operating conditions of equipment such as a pump, and so forth, an inner volume, pressure, temperature, and so on, with respect to a tank, in order to enable the operator to execute operation and monitoring during operation through the intermediary of a display screen.

For this reason, an engineer executes numerous setting for color change, the number of display digits, and touch function on the graphic object file. In general, the operator adjusts equipment parameters with the aim of operating for high-efficiency production while bearing in mind P & I D (Pipe and Instrument diagram), and PFD (Process Flow Diagram).

Accordingly, with graphic windows displayed in the operation•monitoring device 10, as well, the number of P & I D-based windows inevitably increases, so that there arises the need for executing setting at as many as several thousand points on one sheet of the graphic object file.

FIGS. 10(A), 10(B) each are a block diagram of the graphic object file for exhibiting a P & I D-based display. In both the figures, many exhibits of similar units and equipment are joined together, and pumps and control valves are displayed to have the same color change and tag name, respectively, in any of graphics.

Further, characters starting with $ (for example, $ TAG, and $ Process) each is a graphic general-purpose name, and a target equipment name (for example, a tag name) in association with the general-purpose name is displayed when the graphic window is displayed.

The units displayed in FIGS. 10(A), 10(B), respectively, appear to differ from each other at first glance, but those units differ from each other only in respect of a physical layout, displaying the same process. A graphic display screen for use in operation•monitoring of the plant is preferably in agreement with an actual physical layout. More specifically, a plant line is extended not only horizontally but also perpendicularly, and whether the control valve is seen positioned on a front side (the right-hand side) or a back side (the left-hand side) will be important from an operational point of view.

It will take a large number of man-hours to form such graphic elements differing in display form from each other on an item-by item basis. Accordingly, if identical elements differing in display form from each other can be turned into link parts, respectively, to be thereby utilized, this will enable engineering efficiency of the graphic object file to be enhanced.
[Patent Document 1] JP 2002-140114 A

A conventional graphic information generation system utilizing link parts has the following problems.

(1) Since modification of a link part is not permitted at all at a quote-destination, the link part cannot be used for general purpose unless a size of the link part, namely, a unit of part formation is rendered small.

(2) FIG. 11 is a schematic diagram describing a link part unit according to a conventional technique. A control valve horizontally disposed, with modify-conditions set therein, represents a link part unit, and a control valve identical thereto, differing in orientation, cannot be used as a link part, so that such a control valve need be separately edited to be retained as another link part.

(3) If the size of a link part is small, setting items prepared in the respective graphic windows will not be much different from those in the case where no link part is used, so that improvement in engineering efficiency cannot be expected at all.

(4) Assuming that a link part is formed so as to be small in size, a display color and modify-conditions are determined depending on conditions of a quote-destination, so that linkage need be removed at the quote-destination in reality to thereby execute be resetting. Since a concept of regrouping does not exist, once a group is freed, link-catalog is freed. Accordingly, even if a link part is altered at a quote-source, this will not be reflected at a quote-destination, so that there occurs the need for maintenance work for every graphic object file at the quote-destination.

(5) Since the concept of regrouping does not exist, it is not possible to implement nesting of a link part, that is, generation of a link part in a form with another link part contained therein. Accordingly, a link part large in size cannot be formed by regeneration.

### SUMMARY OF THE INVENTION

The invention has been developed to solve those problems described, and it is therefore an object of the invention to provide a graphic information generation system capable of allowing alteration at a quote-destination with linkage kept in continuous state, and enlarging a link part size by integrating similar link parts in one, to thereby implement customizing.

To solve those problems described as above, the invention has the following configurations.

(1) In a graphic information generation system for generating a graphic object file by quoting a predetermined link part from a link part tool for retaining link parts for graphic display into graphic builder means while link-cataloging the link part quoted in the link part tool, the graphic information generation system comprises a customizing processor for customizing the link part as quoted, and link-cataloging a customized part in the link part tool.

(2) The graphic information generation system as set forth under item (1) as above, wherein the customizing processor holds customizing information, and update processing whereby higher priority is given to customizing is executed when a link-cataloged part quoted in the graphic object file is updated in batch processing.

(3) The graphic information generation system as set forth under item (1) or (2) as above, wherein the customizing processor retains a customized part generated by referring to an optional link part retained in the link part tool.

(4) The graphic information generation system as set forth under any of items (1) to (3) as above, wherein the customizing processor retains and link-catalogs a customized part generated by referring to the graphic object file in the link part tool.

(5) The graphic information generation system as set forth under item (4) as above, wherein the customizing processor converts a spot in the graphic object file as referred to, not written by a general-purpose name, into a general-purpose name to be thereby retained, and link-cataloged in the link part tool.

(6) The graphic information generation system as set forth under any of items (1) to (5) as above, wherein the customizing processor comprises setting item select means enabling selection of a setting item to be added to the customized part.

(7) The graphic information generation system as set forth under item (6) as above, wherein the setting item select means selects at least any one selected from the group consisting of presence or absence of display, size, location, rotation, color, and presence or absence of modify-conditions.

(8) The graphic information generation system as set forth under any of items (1) to (7) as above, wherein the customizing processor has a nesting function for generating a customized part by embedding another part in a link part.

(9) The graphic information generation system as set forth under any of items (1) to (8) as above, wherein the customizing processor frees a group of link parts as grouped, and regroups the link parts after editing, to thereby execute customizing.

According to the invention, the following effects can be expected.

(1) A link part at a quote-destination can be customized, and even if a link part at a quote source is altered, update processing is executed such that content customized at a quote-destination is given higher priority. By so doing, flexibility at the quote-destination is increased, and the graphic object file resembling actual P & I D can be formed in short time.

(2) Further, since a link part can be nested, a link part greater in size can be formed by embedding another link part in a link part, thereby enhancing generation efficiency of the graphic object file. It is possible to form, for example, a part with an eye on a unit greater in size than equipment, and a part equal in size to a control valve, process data character display, and pump, joined together.

(3) If any at a quote-destination can be customized, a user will have difficulty in determining parentage (between a quote-source, and a quote-destination) between link parts. Accordingly, the graphic builder means have customizable setting items in a file, and can limit items displayed in the setting items at a quote-destination to the customizable setting items only.

(4) It is possible to form a part with the largest resource regardless of a relation between modeling generally used in software, and an instance, and to add alteration to the part at a quote-destination from a visual point of view, thereby selecting whether or not setting items are displayed. Hence the engineer having no particular knowledge on software can add alteration by intuition.

(5) By selecting non-display against individual display items of a link part at a quote-destination, it becomes possible to display only necessary items at the quote-destination with linkage in continuous state. As a result, by forming a link part with the largest resource, the same link part can be used even at a spot of the smallest resource in display conditions.

(6) By selecting rotation against individual display items of a link part at a quote-destination, display adapted to conditions at the quote-destination is enabled with linkage kept in continuous state. For example, a line tends to be generally perceived as horizontally oriented, but is also perpendicularly extended at an actual plant, in which case, a control valve as well is perpendicularly oriented. Because different link parts were formed in the past, there was an increase in the number of varieties of link parts, depending on affix positions of the parts such as parts oriented horizontally and perpendicularly, respectively, parts oriented toward the front and back faces of the line, respectively, and so forth. However, with the present invention, link parts for every variety, such as equipment, and unit, will be sufficient to meet the needs.

(7) By selecting a position change against individual display items of a link part at a quote-destination, it becomes possible to dispose individual link parts at optional positions, respectively, with linkage kept in continuous state. For example, a control valve, a pump, and a flow meter tend to be generally perceived as disposed at the same position, however, there are cases where the control valve, and the pump are disposed along a horizontal line, and the flow meter is disposed along a perpendicular line in an actual plant. Further, there is no case where the control valve, pump, and flow meter are disposed in series, and these pieces of equipment are disposed independently from each other. If those pieces of equipment are formed of different link parts, respectively, improvement in engineering efficiency cannot be expected. Hence, if three pieces of equipment are each formed of one link part, and each of the equipment is shifted around at the quote-destination, this will allow reduction in the number of operation times for forming the graphic object file, resulting in enhancement of the engineering efficiency.

(8) By selecting presence or absence of modify-conditions against individual display items of a link part at a quote-destination, it becomes possible to select only modify-condition adapted to equipment at the quote-destination with linkage kept in continuous state. For example, with the control valve, a simple ON/OFF system differs in modify condition formula from a flow rate monitor system. If a maximum modify condition pattern is set in a link part, and a modify condition for use at the quote-destination is selected, it need only sufficient to form only one link part even under various conditions.

(9) By selecting color change against individual display items of a link part at a quote-destination, it becomes possible to select color matching a background at the quote-destination. For example, in the case of a graphic colored primarily in red related to a boiler, it is not easy to recognize closing of a control valve colored in red, and therefore, the control valve can be colored in purple.

(10) It is possible to select a link part candidate from the graphic object file already formed, thereby forming a link part. The system automatically allocates a general-purpose name to spots where general-purpose names are not in use. Further, the system automatically applies a link part to the graphic object file side as well. By minimizing an engineering work for generation of link parts, a work for generation of the graphic object file can be established as an engineering style based mainly on link parts.

(11) Even if setting of respective display items at a quote-destination is altered, information on whether or not the setting was altered is left with the system, so that linkage can be continued with such an alteration at the quote-destination being left out. For example, when a display color of an industrial unit needs to be fixed in white after generation of the graphic object file, graphic displays at the quote-destination are all altered by altering a display color at a quote-source. Needless to say, in the case of altering a display color at the quote-destination, alteration at the quote-destination takes precedence over that at the quote-source.

### BRIEF DESCRIPTION OF THE DRAWINGS

FIG. 1 is a functional block diagram showing one embodiment of a graphic information generation system according to the invention;

FIG. 2 is a functional block diagram showing a configuration example of a distributed computer control system to which the graphic information generation system according to the invention is connected;

FIG. 3 is a function-correlation view concerning editing, retaining, quoting, link-cataloging, and updating with respect to the link part;

FIG. 4 is a transition view showing a process for generating a customized part by referring to a link part that is retained;

FIG. 5 is a transition view showing a process for generating a graphic object file;

FIG. 6 is a transition view showing a process for generating the customized part by referring to the existing graphic object file as retained;

FIG. 7 is a transition view showing a process for editing and updating of the link parts;

FIG. 8 is a functional block diagram showing a configuration example of a distributed computer control system to which a conventional graphic information generation system is connected;

FIG. 9 is a functional correlation view concerning editing, retaining, quoting, link-cataloging, and updating with respect to a link part;

FIGS. 10(A), 10(B) each are a block diagram of a graphic object file for exhibiting a P & I D-based display; and

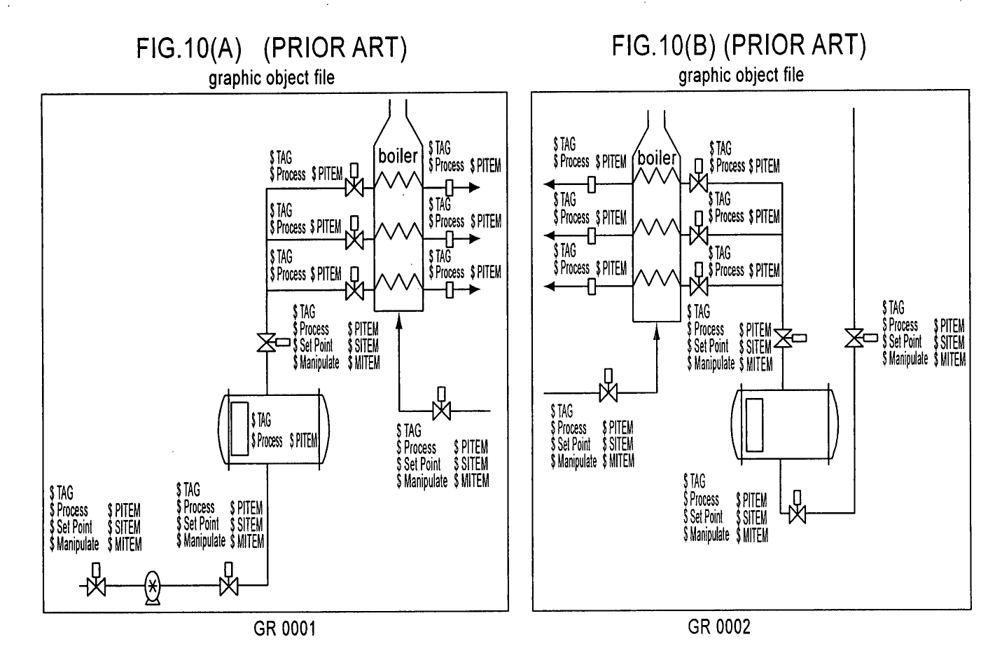

FIG. 11 is a schematic diagram describing a link part unit according to a conventional technique

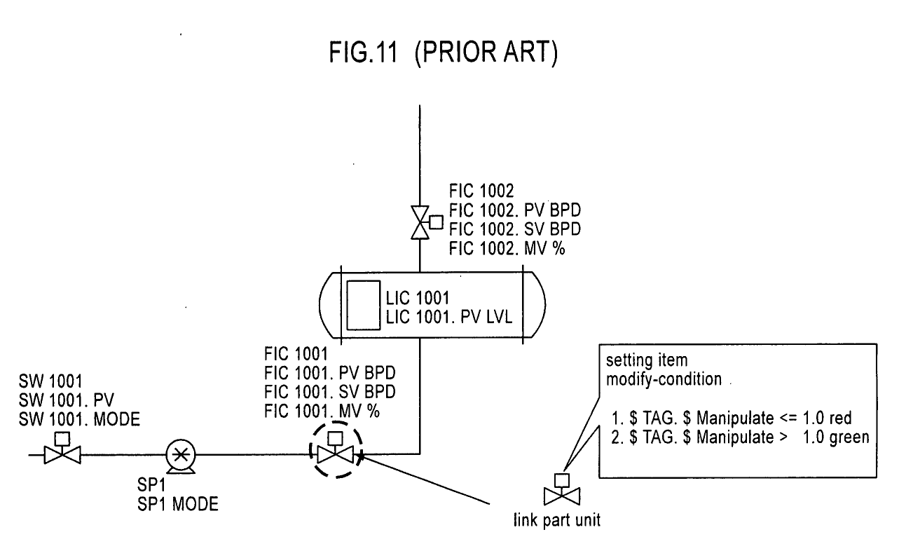

### DETAILED DESCRIPTION OF THE PREFERRED EMBODIMENTS

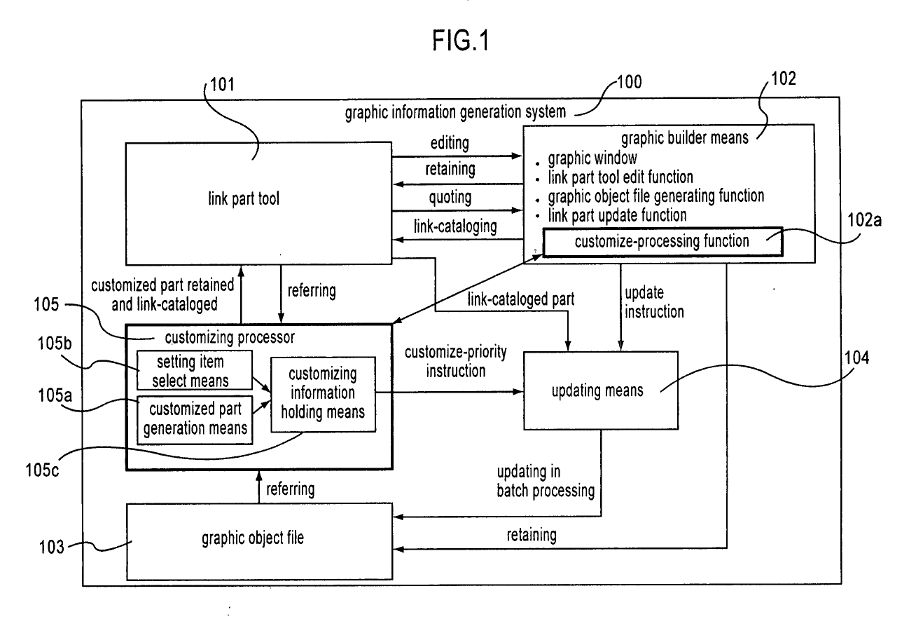

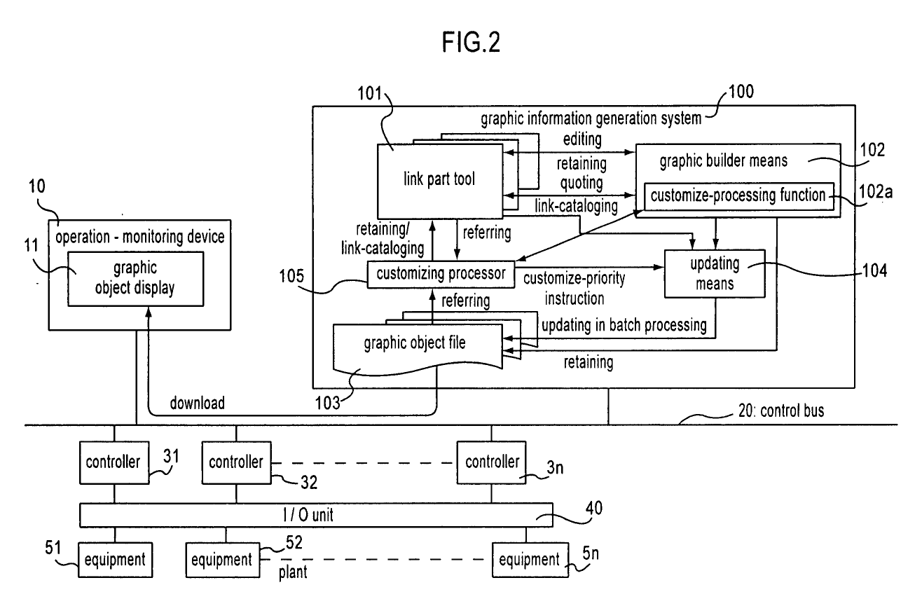

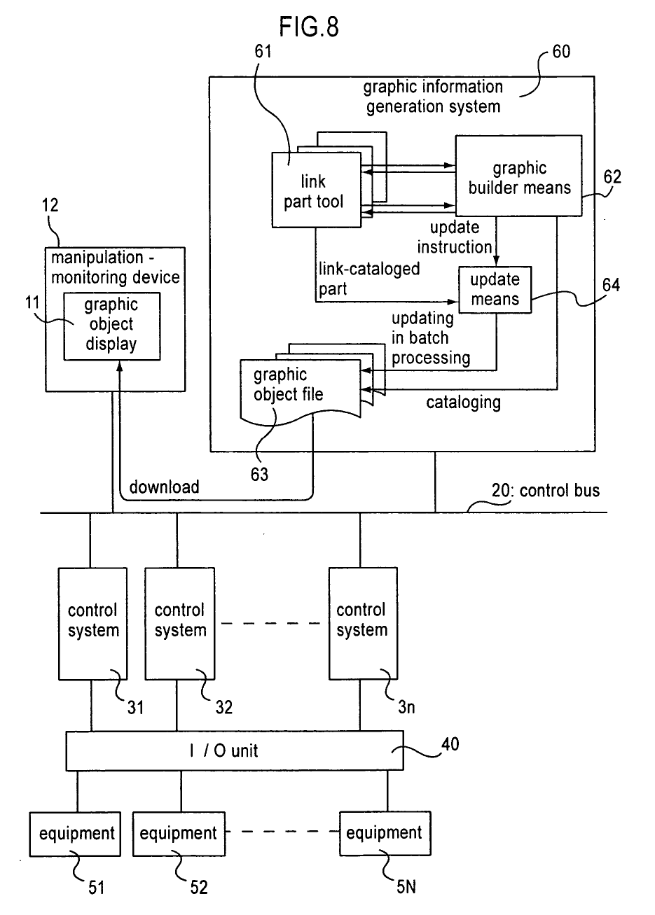

Embodiments of the invention are described hereinafter with reference to the accompanying drawings. FIG. 1 is a functional block diagram showing one embodiment of a graphic information generation system according to the invention. FIG. 2 is a functional block diagram showing a configuration example of a distributed computer control system to which the graphic information generation system according to the invention is connected. In the figures, elements identical to those of the conventional system described with reference to FIG. 8 are denoted by like reference numerals, respectively, omitting therefore description thereof.

A graphic information generation system 100 according to the invention comprises a link part tool 101, graphic builder means 102, a graphic object file 103, and updating means 104. Those elements each have a function identical to that of each of the elements of the conventional system described with reference to FIG. 8, namely, the link part tool 61, the graphic builder means 62, the graphic object file 63, and the updating means 64.

The graphic builder means 102 is provided with a graphic window for executing various processing through dialogue with an operator, as in the case of the graphic builder means 62, while a link part tool edit function, graphic object file generating function, and link part update function of the graphic builder means 102 are the same as corresponding functions of the conventional graphic builder means 62.

In the graphic builder means 102, a function added to those functions of the conventional system is a customize-processing function 102a. The customize-processing function 102a in collaboration with a customizing processor 105 as newly added executes customized processing unique to the present invention.

The customizing processor 105 comprises customized part generation means 105a, setting item select means 105b, and customizing information holding means 105c. As to the basic function of the customizing processor 105, a customized part generated by the customized part generation means 105a is retained and link-cataloged in the link part tool as a quote-source while information subjected to the customized processing is delivered to the customizing information holding means 105c to be held therein.

When a link-cataloged part quoted in the graphic object file 103 is updated in batch processing by the updating means 104, update processing whereby higher priority is given to customizing is executed on the basis of a customize-priority instruction from the customizing information holding means 105c.

Owing to the updating in batch processing for giving higher priority to customizing, the customized part as link-cataloged will not be forcibly rewritten by the link part tool as the quote source with linkage in continuous state, so that it becomes possible to execute the updating of link parts in the graphic object file 103 by batch processing.

The customizing processor 105 has a function whereby a customized part generated by referring to an optional link part retained in the link part tool 101 is retained as a new link part in the link part tool 101.

Further, the customizing processor 105 has a function whereby a customized part generated by referring to the graphic object file 103 as retained is retained and link-cataloged in the link part tool 101.

In this case, a spot (actual equipment display) in the graphic object file 103 as referred to, not written by a general-purpose name, is automatically converted into a general-purpose name to be thereby retained, and link-cataloged in the link part tool 101.

Still further, the customizing processor 105 has a function whereby selection of a setting item to be added to the customized part is enabled by the setting item select means 105b. A selection target of the setting item is at least any one selected from the group consisting of presence or absence of display, size, location, rotation, color, and presence or absence of modify-conditions.

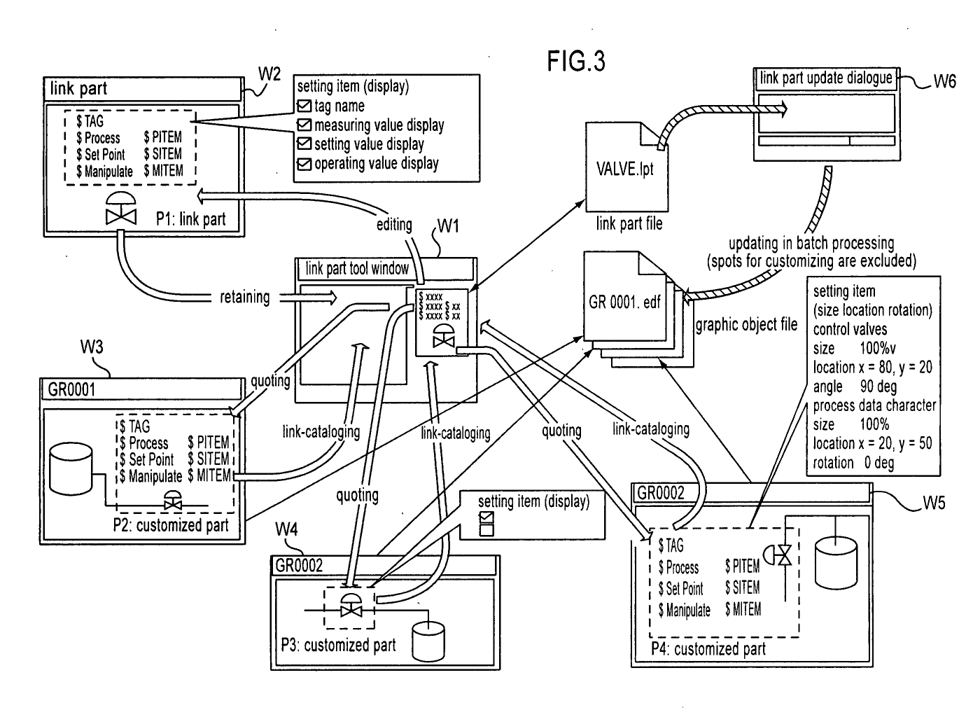

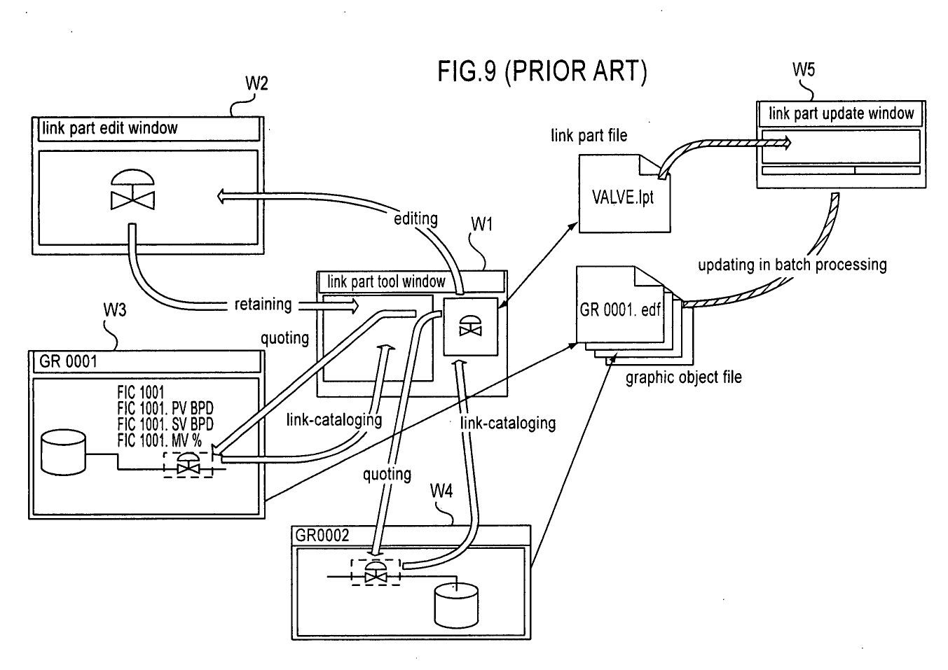

FIG. 3 is a function-correlation view concerning editing, retaining, quoting, link-cataloging, and updating with respect to the link part. A link part tool file is managed by a link part tool window W1. The editing of the link part is executed by calling up a link part as an edit target to an edit window W2, and edit results are retained in the link part tool file via the link part tool window W1. The function described is the same as that for the conventional system described with reference to FIG. 9.

At the time of quoting a link part, a link part P1 as retained is called up in the link part tool window W1 to be then edited in graphic windows W3, W4, W5, and edit results thereof are retained in the graphic object files GR0001.edf, GR0002.edf, and GR0003.edf while customized parts P2, P3, and P4, obtained by customizing the link part P1 as quoted, are link-cataloged in the link part tool via the link part tool window W1.

In the update processing, the link part file as link-cataloged in a link part update window W6 is called up, and the link parts quoted in the graphic object file as the quote-destination are updated in batch processing to be thereby replaced with the latest data.

Each of the graphic object files holds update history information, and detects mismatch between a link part at a quote-destination, and the link part file by utilizing the information, thereby updating the link part so as to match the content of the link part file, however, spots for customizing are excluded from targets for the updating in batch processing.

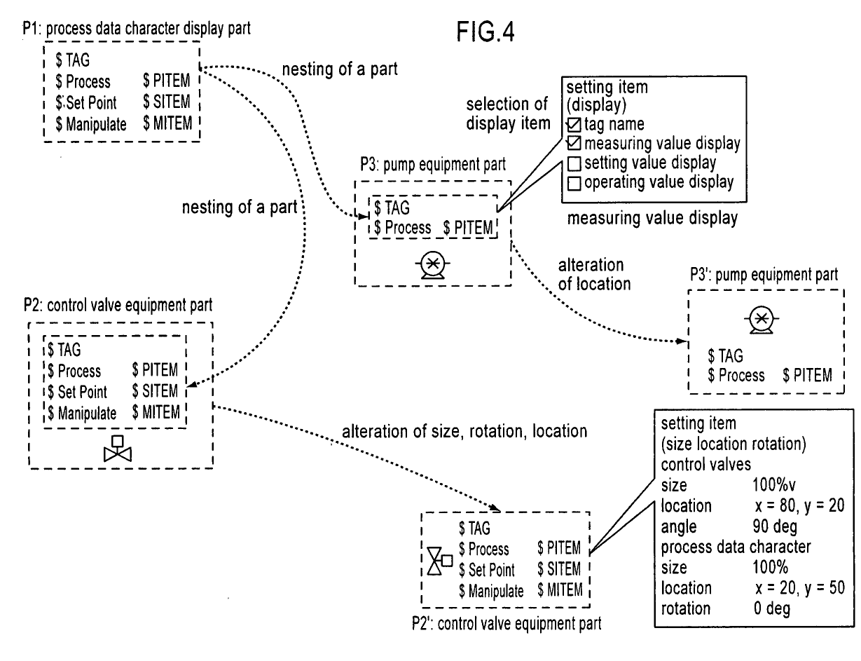

FIG. 4 is a transition view showing a process for generating a customized part by referring to a link part that is retained. A process data character display part P1 is retained as the link part. The engineer takes the following steps to execute customizing.

(1) A control valve equipment part P2 is affixed onto a graphic window, and a customized part with the process data character display part P1 nested in control valve equipment part P2 is generated to be retained, and is link-cataloged in the process data character display part P1.

(2) The control valve equipment part P2 as retained is affixed onto a graphic window, and a group is once freed.

(2-1) A control valve in a state as clicked with a mouse is moved as it is to a target position to be manipulated for rotation. Similarly, process data character display in a state as-clicked with the mouse is moved as it is to a target position.

(2-3) A customized part P2′ as regrouped is retained, and is link-cataloged in the control valve equipment part P2.

(3) A pump equipment part P3 is affixed onto a graphic window, and a customized part with the process data character display part P1 nested in the pump equipment part P3 is generated.

(3-1) A customized part with tag name and measured value display, selected as display items, is edited to be retained, and is link-cataloged in the process data character display part P1.

(3-2) The pump equipment part P3 as retained is affixed onto a graphic window, and a group is once freed.

(3-3) The process data character display in a state as clicked with the mouse is moved as it is to a target position. Similarly, the pump in a state as clicked with the mouse is moved as it is to a target position.

(3-4) A customized part P3′ as regrouped is retained and is link-cataloged in the pump equipment part P3.

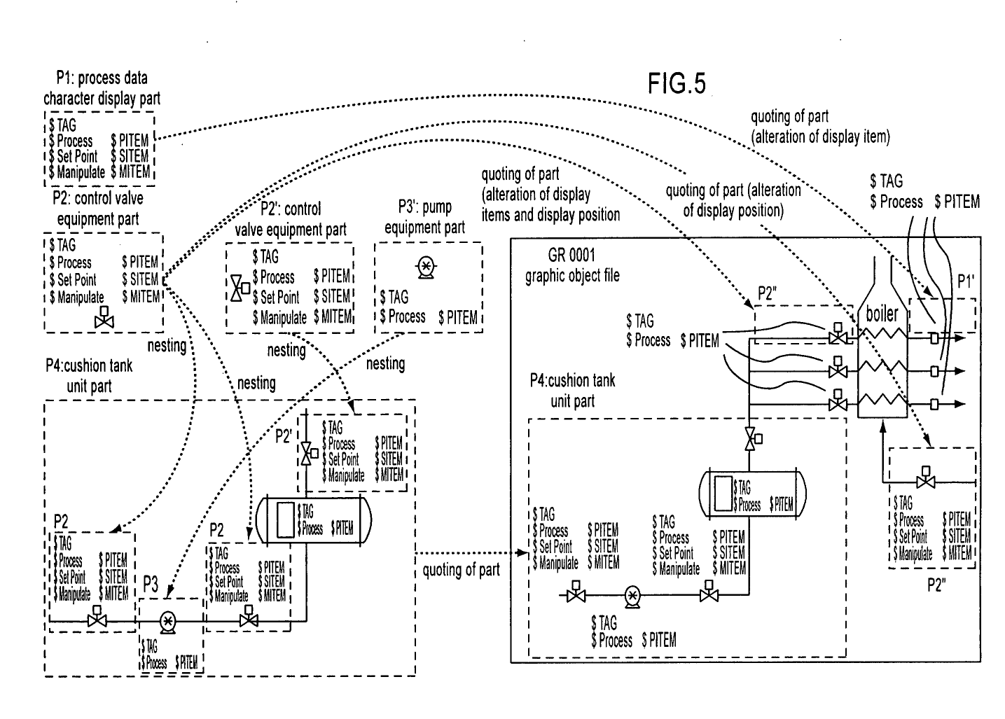

FIG. 5 is a transition view showing a process for generating the graphic object file by quoting the process data character display part P1, and the customized parts P2, P2′, P3′, generated as shown in FIG. 4. The engineer takes the following steps to execute customizing.

(1) A cushion tank part is called up from a listing of parts to be then affixed to a graphic window, and the customized parts P2, P2′, P3′, as retained, are called up and nested in a cushion tank unit part while rendering horizontal and perpendicular pipelines, thereby generating a cushion tank unit part P4 as customized to be subsequently retained.

(2) Components of a boiler, and three lines of a temperature adjust equipment components, disposed on the right side thereof, are affixed onto an edit screen of the graphic object file to thereby render connection with the boiler, and a file name GR 0001 is assigned thereto. The cushion tank unit part P4 retained in the file is quoted to be subsequently affixed to a predetermined position.

(3) The control valve equipment part P2 is called up, and the customized part P2″ with display items and display position, altered respectively, is affixed to three lines on the left side of the boiler and a lower part thereof, to thereby render connection with the boiler. Similarly, connection between a control valve equipment part P2″ in three lines, and the cushion tank unit part P4 is rendered.

(4) The process data character display part P1 is called up, and a customized part P1′ obtained by altering the display items of the process data character display part P1 is affixed to an upper part of the three lines of the temperature adjust equipment, on the right side of the boiler.

(5) Actual tag names are assigned to general-purpose names in the graphic object file GR 0001 as completed, respectively, and an edit content is retained.

In the case of generating the graphic object file by taking those steps described, an operation is executed mostly by quoting the customized parts in the form of individual link parts, and an edit work is completed only by rendering some connections, and assigning the actual tag names to the general-purpose names, respectively.

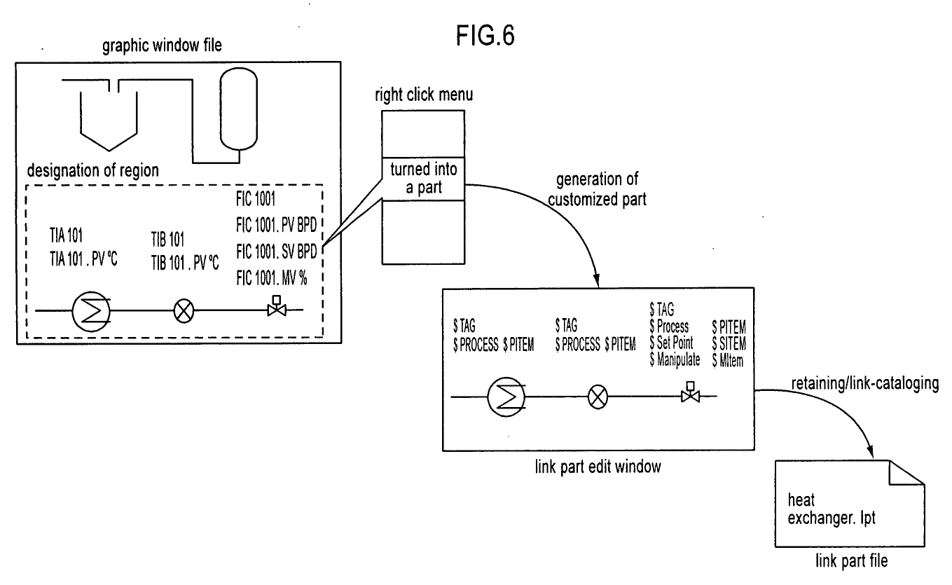

FIG. 6 is a transition view showing a process for generating the customized part by referring to the existing graphic object file as retained. The engineer takes the following steps to execute customizing.

(1) The graphic object file GR0002 is opened for generation of a customized part of JOB original from GR0002 already generated.

(2) A region to be turned into one of the parts is selected by operation with the mouse to thereby display a right click menu, and “turned into a part” on the right click menu is selected.

(3) The system displays a link part edit window. At this point in time, the system automatically replaces all items set in actual tag names with general-purpose names, respectively.

(4) An edit content containing an edited customized part with a link part name as “heat exchanger” is retained. The system retains the edit content as-grouped state while link-cataloging the region turned into the part as a link part.

(5) The system automatically assigns an actual tag name to the general-purpose name in a heat exchanger part. The engineer overwrites the graphic window GR0002 to be retained.

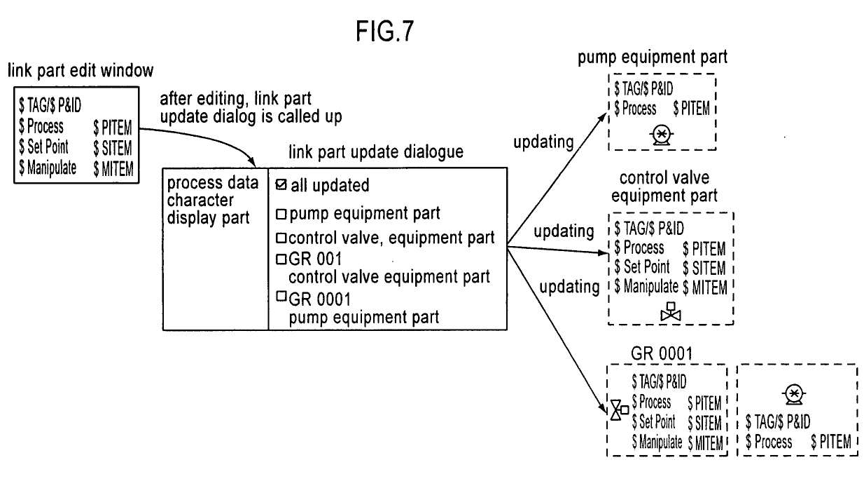

FIG. 7 is a transition view showing a process for editing and updating of link parts. With the present embodiment, there is described an embodiment wherein “P & I D” instrumentation symbols are written along the right side of tag names displayed in the process data character display part. The engineer takes the following steps to execute update processing.

(1) A link part as a edit target in a link part edit window is called up to be displayed, and “P & I D” instrumentation symbol names are additionally written for editing, along the right side of tag names, whereupon the process data character display part as edited is overwritten to be subsequently retained.

(2) A link part update dialog is displayed. The system displays a listing of link parts as update targets, and graphic windows as quote-destinations. The engineer checks whether or not all the link parts are to be updated.

(3) The system updates, in batch processing, link parts being used in the graphic window at a quote-destination. In this case, updating is applied to items customized at a quote-destination such that content customized with the link part at the quote-destination takes precedence over an edit content of the link part at a quote source.

As described in the foregoing, with the present invention, a link part can be nested, and the link part at a quote-destination can be customized in a link part greater in size with linkage kept in the continuous state, so that it is possible to provide workings whereby the generation efficiency of the graphic object file is enhanced.

The conventional techniques are based on the premise that a quote-source is in complete agreement with a quote-destination, so that it has been impossible to permit primitive un-assignment within a link part, alteration in primitive orientation, display position, and so forth. Accordingly, only a component small in size, such as a picture of a control valve, has been used as a link part.

In contrast, with the present invention, a customized part can be formed of the largest resource, and can be adjusted so as to be adapted to conditions of a graphic object file at a quote-destination. Furthermore, since nesting of a part is possible, a link part large in size can be formed. As a result, significant improvement in efficiency of engineering for generation of the graphic object file can be expected.

What is claimed is:

1. A graphic information generation system for generating a graphic object file by quoting a predetermined link part from a link part tool for retaining link parts for graphic display into graphic builder means while link-cataloging the link part quoted in the link part tool, said graphic information generation system comprising a customizing processor for customizing the link part as quoted, and link-cataloging a customized part in the link part tool.

2. The graphic information generation system according to claim 1, wherein the customizing processor holds customizing information, and update processing whereby higher priority is given to customizing is executed when a link-cataloged part quoted in the graphic object file is updated in batch processing.

3. The graphic information generation system according to claim 1, wherein the customizing processor retains a customized part generated by referring to an optional link part retained in the link part tool.

4. The graphic information generation system according to any of claim 1, wherein the customizing processor retains and link-catalogs a customized part generated by referring to the graphic object file in the link part tool.

5. The graphic information generation system according to claim 4, wherein the customizing processor converts a spot in the graphic object file as referred to, not written by a general-purpose name, into a general-purpose name to be thereby retained, and link-cataloged in the link part tool.

6. The graphic information generation system according claim 1, wherein the customizing processor comprises setting item select means enabling selection of a setting item to be added to the customized part.

7. The graphic information generation system according to claim 6, wherein the setting item select means selects at least any one selected from the group consisting of presence or absence of display, size, location, rotation, color, and presence or absence of modify-conditions.

8. The graphic information generation system according to claim 1, wherein the customizing processor has a nesting function for generating a customized part by embedding another part in a link part.

9. The graphic information generation system according to claim 1, wherein the customizing processor frees a group of link parts as grouped, and regroups the link parts after editing, to thereby execute customizing.
